(19) United States
(12) Patent Application Publication
(10) Pub. No.: US 2026/0079541 A1
(43) Pub. Date: Mar. 19, 2026

(54) RAPID ASSEMBLY KEYBOARD

(71) Applicant: Dell Products L.P., Round Rock, TX (US)

(72) Inventors: Wen Pin HUANG, New Taipei City (TW); Po Chun HOU, Taipei City (TW); Yi Chen WANG, Taoyuan City (TW); Hsien Tsan CHANG, Taoyan City (TW); Ernesto RAMIREZ, Austin, TX (US); Jason MORRISON, Chadron, NE (US)

(73) Assignee: Dell Products L.P., Round Rock, TX (US)

(21) Appl. No.: 18/888,958

(22) Filed: Sep. 18, 2024

(51) Int. Cl. G06F 1/16; G06F 3/02

(52) U.S. Cl. CPC G06F 1/1662; G06F 3/0202

(57) ABSTRACT

An information handling system may include a keyboard including a plurality of chassis engagement features, and a chassis including a plurality of keyboard engagement features. The keyboard may be configured to slide relative to the chassis in a first direction such that the plurality of chassis engagement features mechanically couple to the plurality of keyboard engagement features. The keyboard may further be configured to slide relative to the chassis in a second direction such that the plurality of chassis engagement features mechanically uncouple from the plurality of keyboard engagement features.

### TECHNICAL FIELD

The present disclosure relates in general to information handling systems, and more specifically to a rapid assembly keyboard system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include a keyboard or other similar input device to enable a user to enter data and commands. Keyboards may be connected to an information handling system chassis using heat staking (e.g., via the controlled melting of thermoplastic materials). However, connecting a keyboard to an information handling system chassis through heat staking may prevent easy removal of the keyboard if the keyboard needs repairs. For example, entire portions of the information handling system chassis may need to be replaced in order to repair the keyboard.

Alternatively, a keyboard may be connected to an information handling system chassis using fasteners (e.g., screws), which may allow for keyboard replacement without removal of entire portions of the information handling system chassis. However, numerous fasteners may be required to connect the keyboard to the information handling system chassis, which may be time consuming and expensive. Thus, systems and methods to facilitate rapid insertion and removal of keyboards in an information handling system may be desirable.

### SUMMARY

In accordance with the teachings of the present disclosure, the disadvantages and problems associated with existing keyboard assembly and disassembly may be reduced or eliminated.

In accordance with embodiments of the present disclosure, an information handling system may include a keyboard including a plurality of chassis engagement features, and a chassis including a plurality of keyboard engagement features. The keyboard may be configured to slide relative to the chassis in a first direction such that the plurality of chassis engagement features mechanically couple to the plurality of keyboard engagement features. The keyboard may further be configured to slide relative to the chassis in a second direction such that the plurality of chassis engagement features mechanically uncouple from the plurality of keyboard engagement features.

In accordance with embodiments of the present disclosure, a method for making an information handling system may include forming a keyboard including a plurality of chassis engagement features, and forming a chassis including a plurality of keyboard engagement features. The keyboard may be configured to slide relative to the chassis in a first direction such that the plurality of chassis engagement features mechanically couple to the plurality of keyboard engagement features. The keyboard may further be configured to slide relative to the chassis in a second direction such that the plurality of chassis engagement features mechanically uncouple from the plurality of keyboard engagement features.

In accordance with embodiments of the present disclosure, a method of assembling a keyboard to a chassis of an information handling system may include sliding the keyboard relative to the chassis in a first direction such that a plurality of chassis engagement features of the keyboard mechanically couple to a plurality of keyboard engagement features of the chassis.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a perspective view of an example information handling system, in accordance with embodiments of the present disclosure;

FIG. 2A illustrates a perspective view of an example keyboard mechanically coupled to example housing, with selected portions of the housing removed for exposition and clarity, in accordance with embodiments of the present disclosure;

FIG. 2B illustrates a perspective view of an alignment feature of the keyboard and housing of FIG. 2A, in accordance with embodiments of the present disclosure;

FIG. 3A illustrates a perspective, cross-sectional view of an example keyboard mechanically coupled to example housing via an example housing engagement feature and an example keyboard engagement feature, in accordance with embodiments of the present disclosure;

FIGS. 3B and 3C illustrate perspective views of the example housing engagement feature and the example keyboard engagement feature of FIG. 3A in operation, in accordance with embodiments of the present disclosure;

FIG. 4A illustrates a side-elevation, cross-sectional view of an example keyboard mechanically coupled to example housing via another example housing engagement feature and another example keyboard engagement feature, in accordance with embodiments of the present disclosure;

FIGS. 4B and 4C illustrate a “top-down” perspective view of the keyboard engagement feature and the housing engagement feature of FIG. 4A in operation, in accordance with embodiments of the present disclosure;

FIG. 5A illustrates a side-elevation, cross-sectional view of an example keyboard mechanically coupled to example housing via another example housing engagement feature and another example keyboard engagement feature, in accordance with embodiments of the present disclosure;

FIGS. 5B and 5C illustrate a “top-down” perspective view of the keyboard engagement feature and the housing engagement feature of FIG. 5A in operation, in accordance with embodiments of the present disclosure;

FIG. 6A illustrates a side-elevation, cross-sectional view of an example keyboard magnetically coupled to example housing, in accordance with embodiments of the present disclosure;

FIG. 6B illustrates a perspective view of example housing including a plurality of example magnets interspersed among a plurality of example keyboard engagement features, in accordance with embodiments of the present disclosure;

FIGS. 7A-7C illustrate plan views of an example magnetic alignment system for aligning an example keyboard and example housing, in accordance with embodiments of the present disclosure; and

FIG. 8 illustrates a perspective view of an example combined card edge connector coupled to an example keyboard, in accordance with embodiments of the present disclosure.

### DETAILED DESCRIPTION

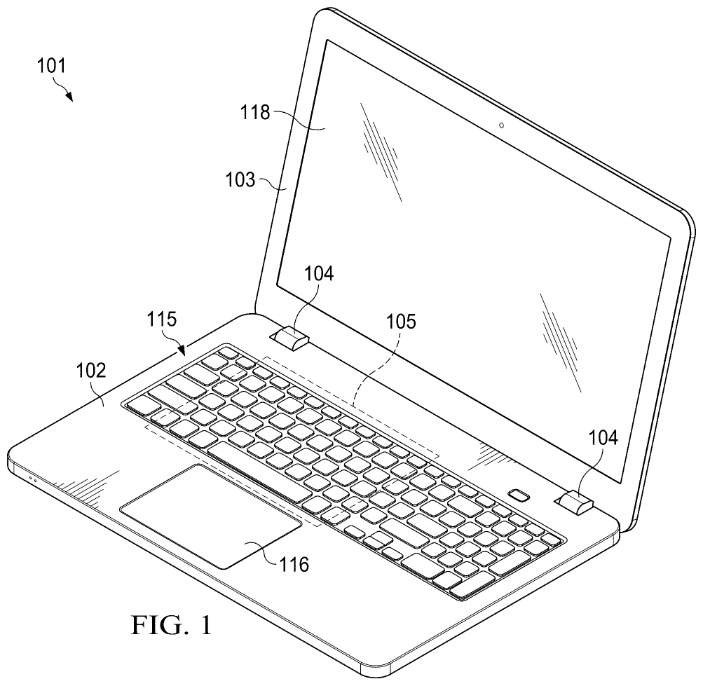

Preferred embodiments and their advantages are best understood by reference to FIGS. 1 through 8, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a perspective view of an example information handling system 101, in accordance with embodiments of the present disclosure. As depicted in FIG. 1, information handling system 101 may comprise a notebook or “laptop” computer. In other embodiments, information handling system 101 may comprise a mobile device sized and shaped to be readily transported and carried on a person of a user of information handling system 101 (e.g., a smartphone, a tablet computing device, a handheld computing device, a personal digital assistant, etc.). As illustrated in FIG. 1, information handling system 101 may comprise a first housing 102, a second housing 103, and one or more hinges 104. First housing 102 may comprise, for example, a main body housing. Accordingly, in some embodiments, a circuit board 105 and other information handling resources may be housed within first housing 102. Circuit board 105 may include one or more information handling resources, including without limitation, one or more processors, one or more memories, and/or one or more peripheral devices.

As also shown in FIG. 1, first housing 102 may include keyboard 115 and a touchpad 116. Keyboard 115 and touchpad 116 may each comprise input devices for receiving input from a user to allow the user to control operation of information handling system 101. In some embodiments, information handling system 101 may comprise other input devices in addition to or instead of touchpad 116.

As illustrated in FIG. 1, second housing 103 may include a display housing and may comprise a display 118 (e.g., a display device or a display module) communicatively coupled to circuit board 105.

Hinge(s) 104 may rotatably couple first housing 102 to second housing 103. Thus, information handling system 101 may be openable and closable (i.e., foldable). In other words, information handling system 101 may be transformable between a first state in which first housing 102 and second housing 103 overlap each other, and a second state in which first housing 102 and second housing 103 are opened and keyboard 115, touchpad 116, and display 118 are exposed to the outside.

Touchpad 116 may comprise an input device having the function of a pointing device and a push button. That is, touchpad 116 may associate a movement of a finger, stylus, or other pointing device tracing the surface of touchpad 116 with the movement of a mouse pointer on a screen of display 118.

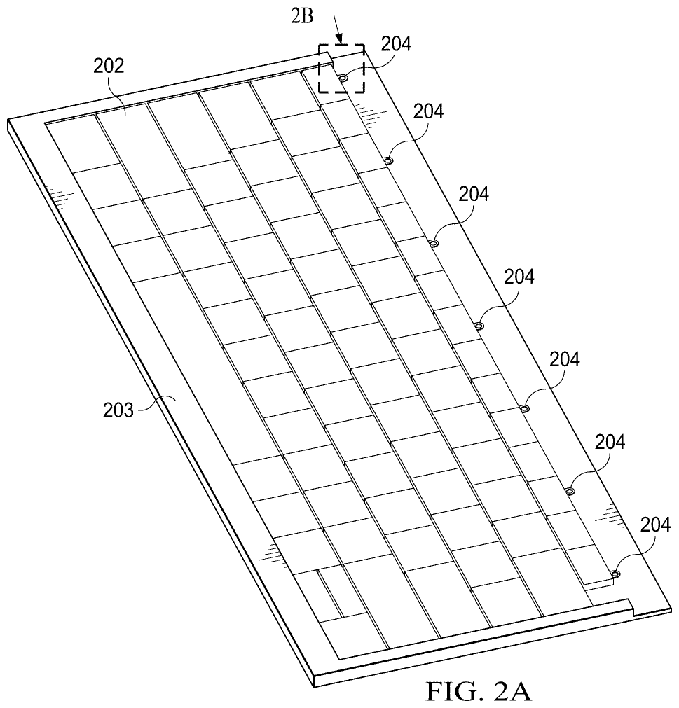

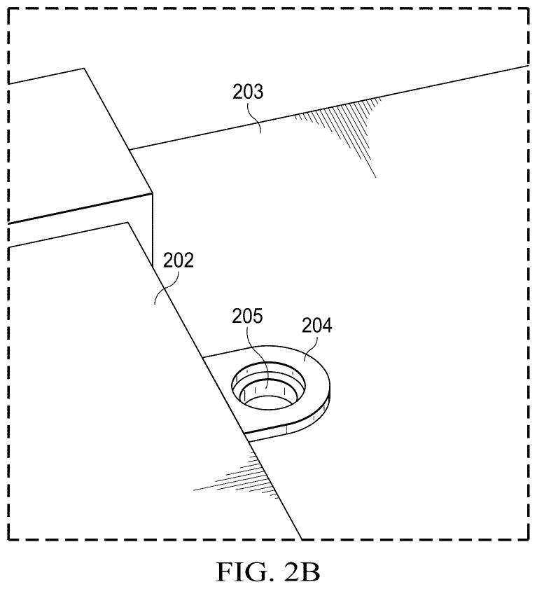

FIG. 2A illustrates a perspective view of an example keyboard 202 mechanically coupled to example housing 203, with selected portions of housing 203 removed for exposition and clarity, in accordance with embodiments of the present disclosure. As described in further detail below, keyboard 202 may comprise a plurality of housing engagement features configured to mechanically couple to and decouple from a plurality of keyboard engagement features of housing 203. In some embodiments, keyboard 202 may further comprise a plurality of alignment brackets 204 protruding beyond a side of keyboard 202. Each alignment bracket 204 may be configured to align with a hole 205 formed in housing 203 (see FIG. 2B) such that when alignment brackets 204 align with holes 205, the plurality of housing engagement features of keyboard 202 is mechanically engaged with the plurality of keyboard engagement features of housing 203. While not shown, in some embodiments a user may insert fasteners (e.g., screws) through alignment brackets 204 and holes 205 to further secure keyboard 202 to housing 203. In some embodiments, a user may mechanically couple an upper cover (not shown) to housing 203 to cover alignment brackets 204 and holes 205. Thus, alignment of alignment brackets 204 with holes 205 may facilitate proper engagement of the plurality of housing engagement features with the plurality of keyboard features, and may further help to secure keyboard 202 to housing 203.

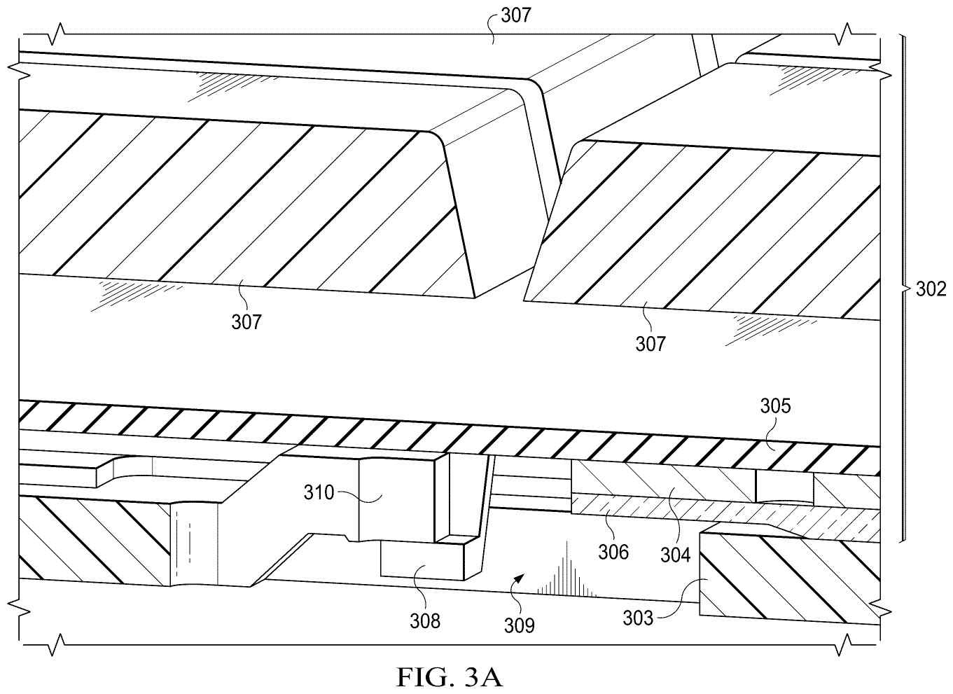

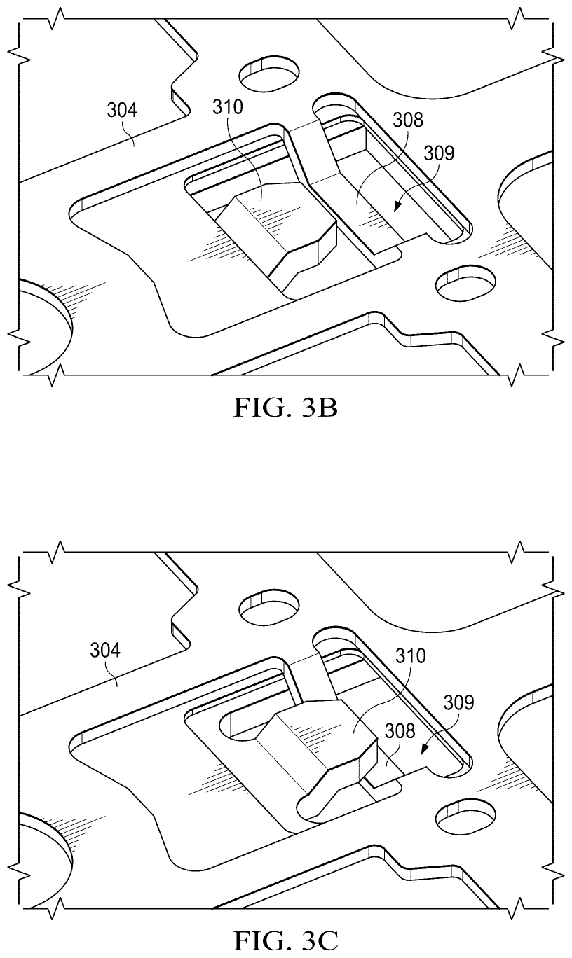

FIG. 3A illustrates a perspective, cross-sectional view of an example keyboard 302 mechanically coupled to example housing 303 via an example housing engagement feature and an example keyboard engagement feature, in accordance with embodiments of the present disclosure. As shown in FIG. 3A, keyboard 302 may comprise a plurality of keys. Each key may be implemented as a metal plate 304 with a membrane 305 formed atop metal plate 304 and a backlight 306 below metal plate 304. Membrane 305 may be insulated from metal plate 304 and may implement a circuit whereby pressure upon membrane 305 (e.g., from a user pressing a keycap 307 of a key) may complete an electrical circuit, thus indicating the user has pressed the key. In some embodiments, backlight 306 may be integrated within membrane 305.

As shown in FIG. 3A, in some embodiments a housing engagement feature of keyboard 302 may comprise a latch 308 formed from metal plate 304 protruding “down” from a “bottom” side of keyboard 302. Latch 308 may be configured to engage with a corresponding keyboard engagement feature of housing 303 in order to mechanically align, guide, and constrain the movement of keyboard 302 relative to housing 303. As shown in FIG. 3A, a keyboard engagement feature of housing 303 may comprise an opening 309 formed in housing 303 and an engagement feature 310 protruding “up” from a “top” side of housing 303. Opening 309 may be configured to receive latch 308, and engagement feature 310 may be configured to mechanically engage (e.g., interlock) with latch 308 such that movement of keyboard 302 relative to housing 303 is constrained.

FIGS. 3B and 3C illustrate perspective views of the example housing engagement feature and the example keyboard engagement feature of FIG. 3A in operation, in accordance with embodiments of the present disclosure. Portions of keyboard 302 have been removed in FIGS. 3B and 3C for exposition and clarity. As shown in FIG. 3B, a user may position keyboard 302 relative to housing 303 such that latch 308 inserts into opening 309 of housing 303 in a first position. The user may then slide keyboard 302 relative to housing 303 to a second position such that latch 308 mechanically engages (e.g., interlocks) with engagement feature 310, constraining movement of keyboard 302 relative to housing 303 (see FIG. 3C).

In some embodiments, when latch 308 mechanically engages with engagement feature 310, an “in place-lock” sound may be heard, thus notifying a user that keyboard 302 is mechanically secured to housing 303. In addition to or in lieu of such sound, and as described above, alignment of alignment brackets 204 with holes 205, as depicted in FIGS. 2A and 2B, may also indicate that keyboard 302 is mechanically secured to housing 303. While not shown, in some embodiments a user may insert fasteners (e.g., screws) through alignment brackets 204 and holes 205 to further secure keyboard 302 to housing 303. In some embodiments, a user may mechanically couple an upper cover (not shown) to housing 303 to cover alignment brackets 204 and holes 205.

While FIGS. 3A-3C illustrate a single latch 308, a single opening 309, and a single engagement feature 310, one of ordinary skill in the art would understand that keyboard 302 may comprise a plurality of latches 308, and that housing 303 may comprise a corresponding plurality of openings 309 and engagement features 310.

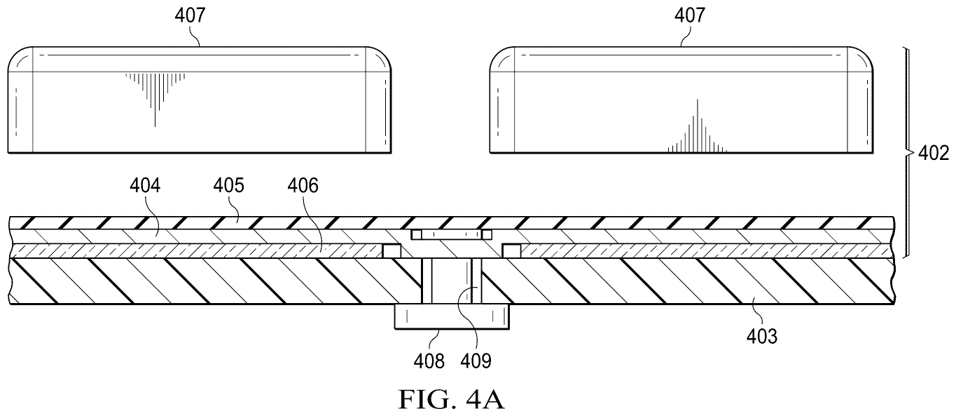

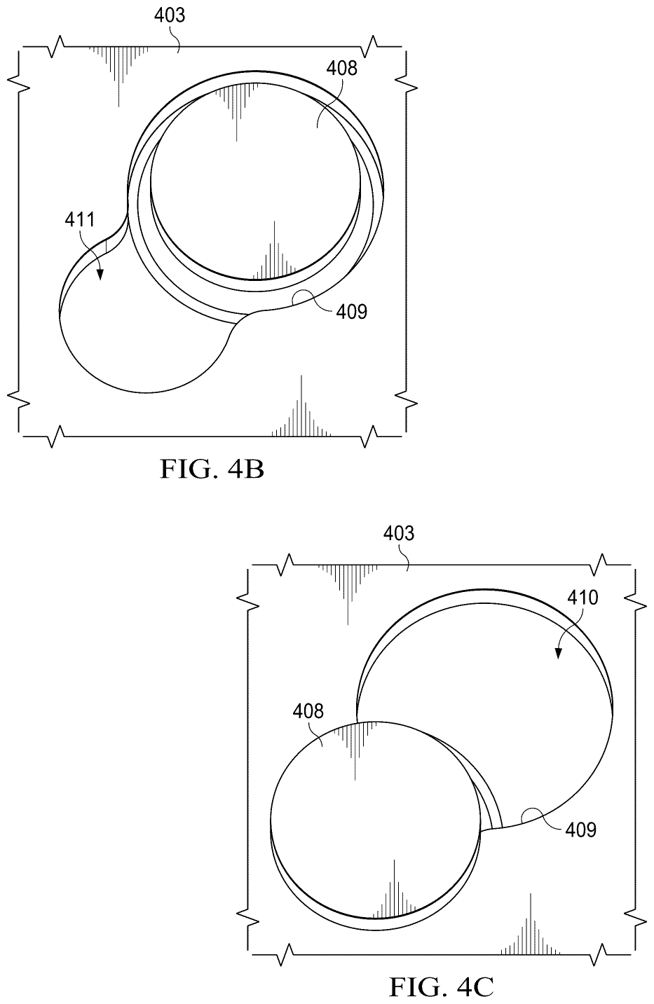

FIG. 4A illustrates a side-elevation, cross-sectional view of an example keyboard 402 mechanically coupled to example housing 403 via another example housing engagement feature and another example keyboard engagement feature, in accordance with embodiments of the present disclosure. Keyboard 402 and housing 403 may be, in many respects, similar to keyboard 302 and housing 303, respectively. Thus, only the main differences between keyboard 302 and keyboard 402, and between housing 303 and housing 403, may be discussed.

As shown in FIG. 4A, in some embodiments a housing engagement feature of keyboard 402 may comprise a standoff 408 protruding “down” from a “bottom” side of keyboard 402. In some embodiments, standoff 408 may comprise a “mushroom head” standoff. Standoff 408 may be configured to engage with a corresponding keyboard engagement feature of housing 403 in order to mechanically align, guide, and constrain the movement of keyboard 402 relative to housing 403. As shown in FIG. 4A, a keyboard engagement feature of housing 403 may comprise an opening 409 formed in housing 403. Opening 409 may be configured to receive and retain standoff 408 to keyboard 402 to housing 403.

FIGS. 4B and 4C illustrate a “top-down” perspective view of the keyboard engagement feature and the housing engagement feature of FIG. 4A in operation, in accordance with embodiments of the present disclosure. In FIGS. 4B and 4C, portions of keyboard 402 have been removed for exposition and clarity. As shown in FIGS. 4B and 4C, in some embodiments opening 409 may comprise a first portion 410 and a second portion 411. In some embodiments, first portion 410 may be larger in size than second portion 411 such that first portion 410 is configured to receive standoff 408, while second portion 411 is configured to retain standoff 408. For example, first portion 410 may be sized such that standoff 408 may be vertically inserted into first portion 410 and removed from first portion 410, and second portion 411 may be sized to prevent vertical insertion and removal of standoff 408 from second portion 411.

As shown in FIG. 4B, in operation a user may position keyboard 402 relative to housing 403 such that standoff 408 inserts into first portion 410 of opening 409 in a first position. The user may then slide keyboard 402 relative to housing 403 to a second position such that standoff 408 is vertically constrained within second portion 411 of opening 409, thereby constraining movement of keyboard 402 relative to housing 403 (see FIG. 4C).

In some embodiments, when standoff 408 mechanically inserts into second portion 411, an “in place-lock” sound may be heard, thus notifying a user that keyboard 402 is mechanically secured within housing 403. In addition to or in lieu of such sound, and as described above, alignment of alignment brackets 204 with holes 205, as depicted in FIGS. 2A and 2B, may also indicate that keyboard 402 is mechanically secured to housing 403. While not shown, in some embodiments a user may insert fasteners (e.g., screws) through alignment brackets 204 and holes 205 to further secure keyboard 402 to housing 403. In some embodiments, a user may mechanically couple an upper cover (not shown) to housing 403 to cover alignment brackets 204 and holes 205.

While FIGS. 4A-4C illustrate a single standoff 408 and a single opening 409, one of ordinary skill in the art would understand that keyboard 402 may comprise a plurality of standoffs 408, and that housing 403 may comprise a corresponding plurality of openings 409.

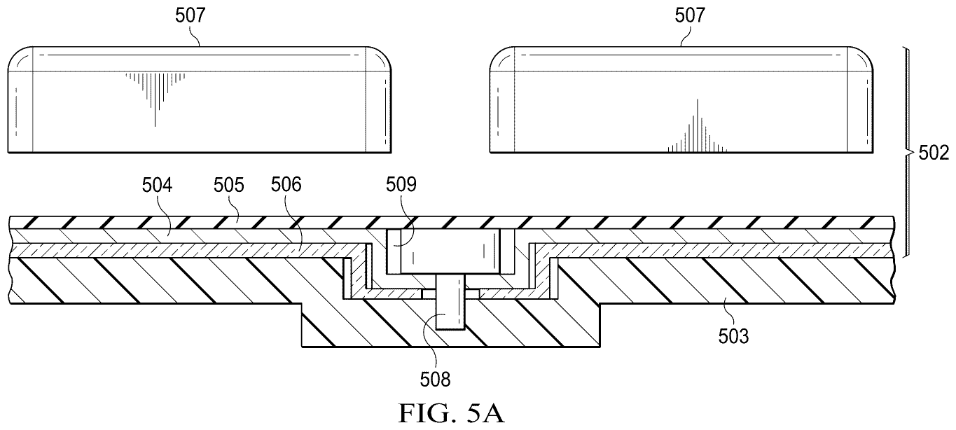

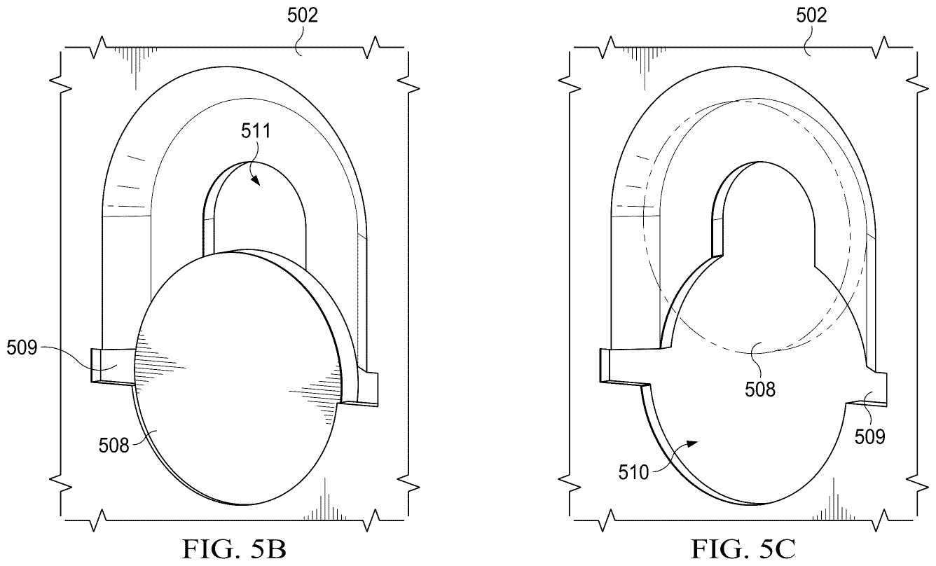

FIG. 5A illustrates a side-elevation, cross-sectional view of an example keyboard 502 mechanically coupled to example housing 503 via another example housing engagement feature and another example keyboard engagement feature, in accordance with embodiments of the present disclosure. Keyboard 502 and housing 503 may be, in many respects, similar to keyboard 302/402 and housing 303/403, respectively. Thus, only the main differences between keyboard 502 and keyboard 302/402, and between housing 503 and housing 303/403, may be discussed.

As shown in FIG. 5A, in some embodiments a keyboard engagement feature of housing 503 may comprise a standoff 508 protruding “up” from a “top” side of housing 503. In some embodiments, standoff 508 may comprise a “mushroom head” standoff. Standoff 508 may be configured to engage with a corresponding housing engagement feature of keyboard 502 in order to mechanically align, guide, and constrain the movement of keyboard 502 relative to housing 503. As shown in FIG. 5A, a housing engagement feature of keyboard 502 may comprise a recess 509 formed below membrane 505 of keyboard 502. Recess 509 may be configured to receive and retain standoff 508 to secure keyboard 502 to housing 503.

FIGS. 5B and 5C illustrate a “top-down” perspective view of the keyboard engagement feature and the housing engagement feature of FIG. 5A in operation, in accordance with embodiments of the present disclosure. Portions of keyboard 502 have been removed for exposition and clarity. As shown in FIGS. 5B and 5C, operation of standoff 508 and recess 509 to secure keyboard 502 to housing 503 is substantially similar to operation of standoff 408 and opening 409 as described above. For example, as shown in FIG. 5B, in operation a user may position keyboard 502 relative to housing 503 such that standoff 508 inserts into first portion 510 of recess 509 in a first position. As shown in FIG. 5C, the user may then slide keyboard 502 relative to housing 503 to a second position such that standoff 508 is vertically constrained within second portion 511 of recess 509, thereby constraining movement of keyboard 502 relative to housing 503 (portions of standoff 508 have been rendered transparent for exposition and clarity).

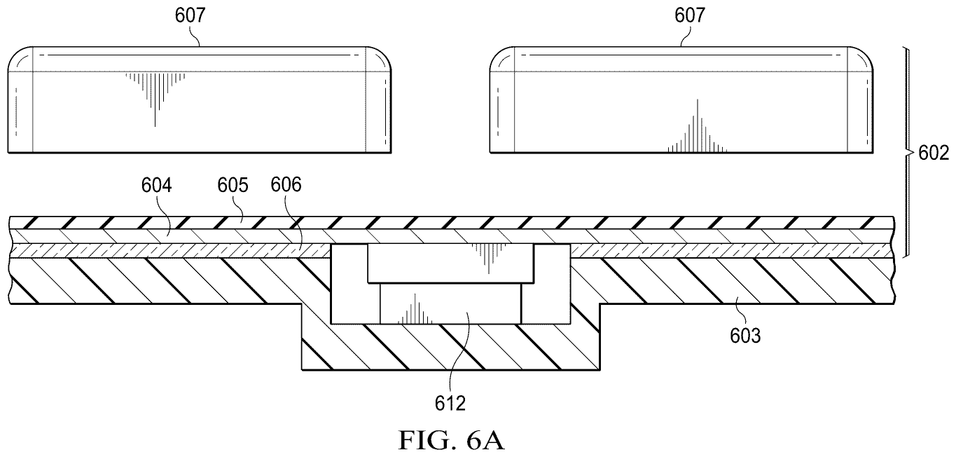

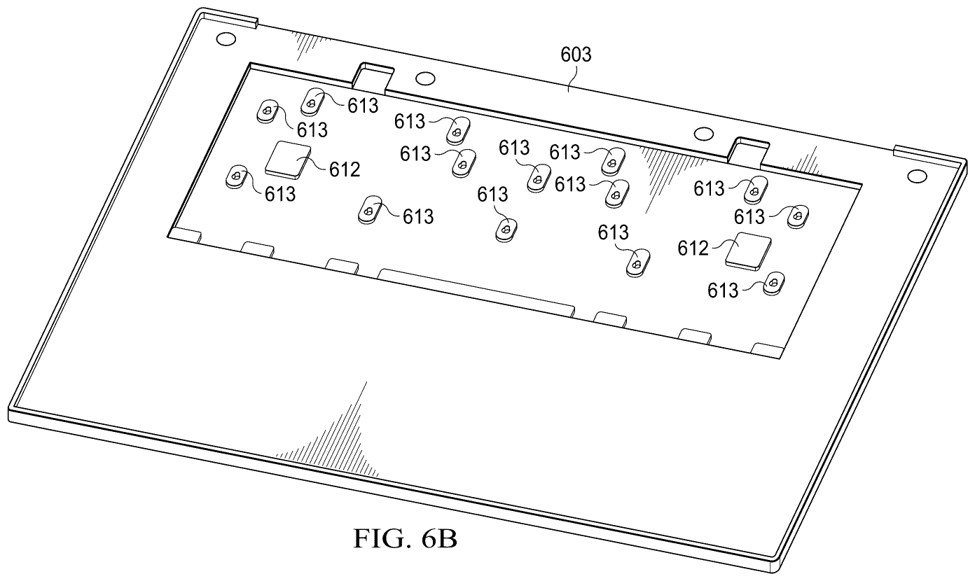

FIG. 6A illustrates a cross-sectional view of keyboard 602 magnetically coupled to housing 603, in accordance with embodiments of the present disclosure. As shown in FIG. 6A, housing 603 may comprise a magnet 612 configured to magnetically couple to metal plate 604 of keyboard 602. In some embodiments, magnet 612 may be configured to magnetically couple to a corresponding magnet coupled to keyboard 602, as described further below.

As shown in FIG. 6B, housing 603 may comprise a plurality of magnets 612 interspersed among a plurality of keyboard engagement features 613. One of skill in the art would appreciate that there may be minimal space or no space separating a “bottom” side of keyboard 602 and a “top” side of housing 603 where the plurality of keyboard engagement features 613 and plurality of housing engagement features (not shown) are mechanically coupled, but that there may be gaps between keyboard 602 and housing 603 where the plurality of keyboard engagement features 613 and plurality of housing engagement features are absent. Thus, the plurality of magnets 612 may be configured to reduce such gaps between keyboard 602 and housing 603.

One of ordinary skill in the art would understand that magnets 612 may be used in conjunction with any of the example keyboard engagement features and housing engagement features described above, and that any suitable number of magnets 612 and keyboard engagement and housing engagement features may be used.

As described above, the plurality of housing engagement features may be coupled to or formed in a “bottom” side of the keyboard, and the plurality of keyboard engagement features may be coupled to or formed in a “top” side of the housing. Because the “bottom” side of the keyboard is positioned on top of the “top” side of the housing, the plurality of keyboard engagement features and plurality of housing engagement features may be hidden from a user when the user installs the keyboard into the housing. Thus, it may be difficult for a user to properly align the plurality of keyboard engagement features and the plurality of housing engagement features.

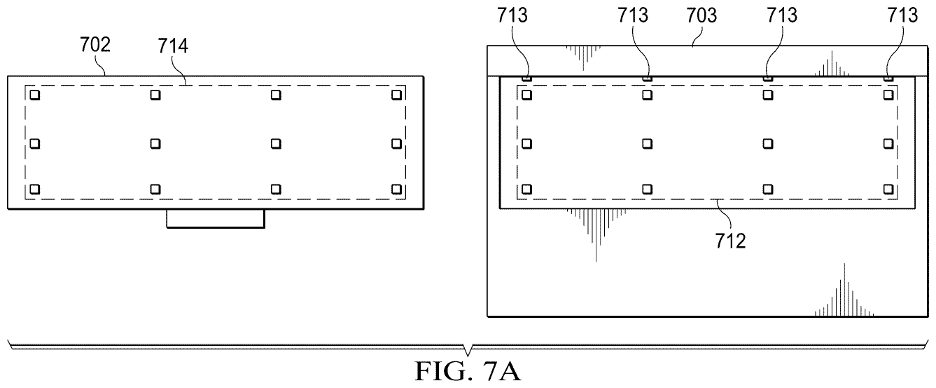

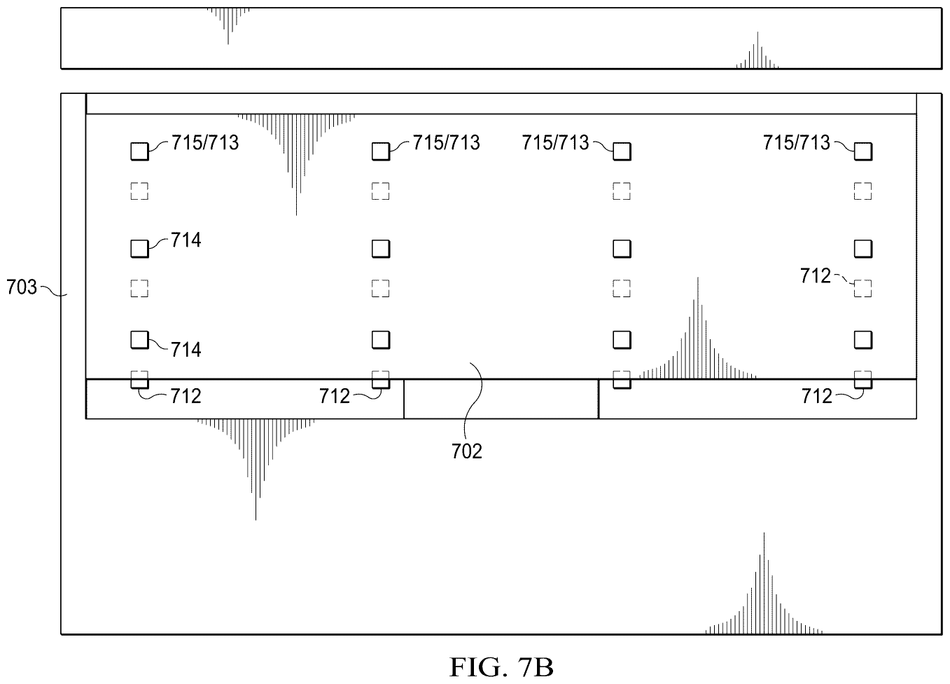

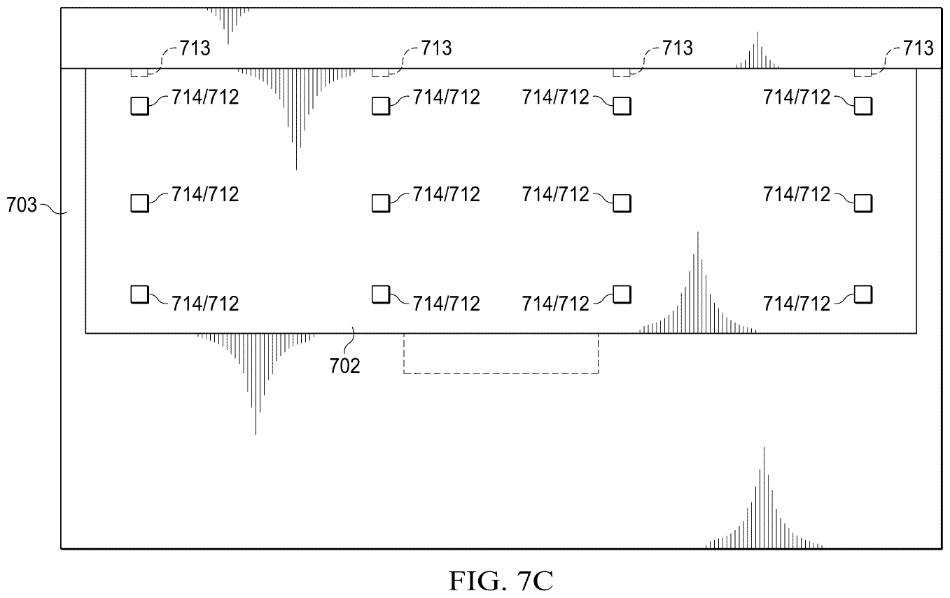

FIGS. 7A-7C illustrate plan views of an example magnetic alignment system configured to facilitate alignment of an example plurality of keyboard engagement features and an example plurality of housing engagement features of example keyboard 702 and example housing 703. While the plurality of keyboard engagement features and the plurality of housing engagement features are not shown for exposition and clarity, one of ordinary skill in the art would understand that the magnetic alignment system described below may be used in conjunction with any of the example keyboard engagement features and housing engagement features described above.

As shown in FIG. 7A, housing 703 may include a first plurality of magnets 712. In some embodiments, magnets 712 may be substantially similar to magnets 612 described above. As further shown in FIG. 7A, housing 703 may further include a plurality of alignment magnets 713 positioned towards a “back” side of housing 703 (e.g., a side closest toward where housing 703 hingedly couples to a display housing). In some embodiments, keyboard 702 may include a second plurality of magnets 714 corresponding to the first plurality of magnets 712.

As shown in FIG. 7B, a sub-plurality 715 of the second plurality of magnets 714 may also be configured to magnetically couple to alignment magnets 713 to facilitate coupling of keyboard 702 to housing 703. For example, in operation a user may align the sub-plurality 715 of the second plurality of magnets 714 with alignment magnets 713 such that a plurality of keyboard engagement features and a plurality of housing engagement features align in a first position. The user may then slide keyboard 702 such that the plurality of keyboard engagement features and the plurality of housing engagement features are mechanically coupled in a second position, thereby securing keyboard 702 to housing 703. In such second position, the first plurality of magnets 712 may align with the second plurality of magnets 714, further securing keyboard 702 to housing 703, and, in some embodiments, reducing gaps between keyboard 702 and housing 703 (see FIG. 7C).

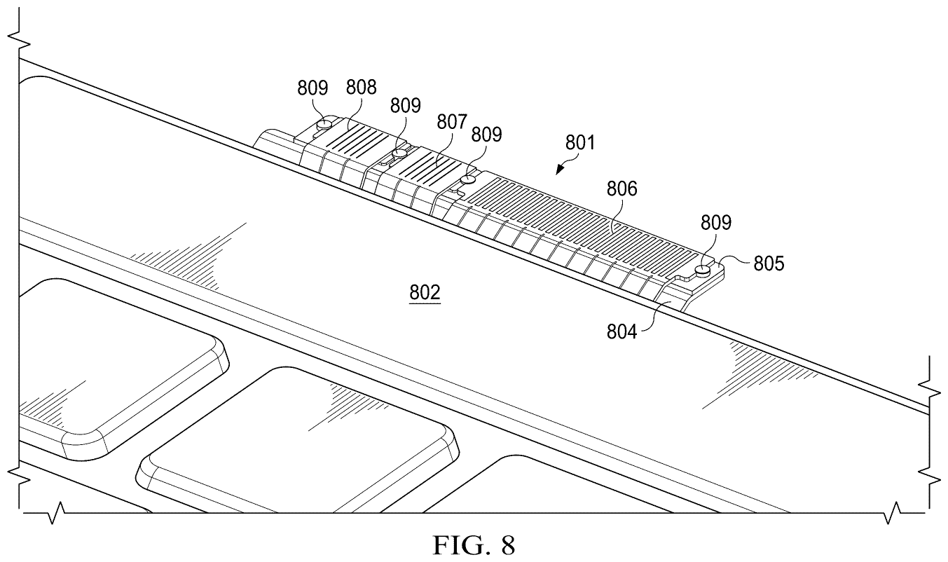

FIG. 8 illustrates a perspective view of an example combined card edge connector 801. As shown in FIG. 8, combined card edge connector 801 may comprise a keyboard plate 804, an alignment spacer 805, keyboard membrane connector 806, keyboard backlight connector 807, and keyboard power connector 808. In some embodiments, alignment spacer 805 may be coupled to keyboard plate 804, and keyboard membrane connector 806, keyboard backlight connector 807, and keyboard power connector 808 may be coupled to alignment spacer 805. In some embodiments, alignment spacer 805 may comprise a plurality of spacers 809 configured to align keyboard membrane connector 806, keyboard backlight connector 807, and power connector 808 in suitable positions.

As shown in FIG. 8, combined card edge connector 801 may protrude beyond a “front” edge of keyboard 802 and may be configured to mechanically and electrically couple to a corresponding connector of an information handling system (not shown). Combined card edge connector 801 may facilitate connection of keyboard 802 to housing of the information handling system by reducing the need for a user to manually connect (e.g., via their hands) keyboard membrane connector 806, keyboard backlight connector 807, and power connector 808 to their respective connectors.

For example, keyboard 802 may comprise combined card edge connector 801 and any of the keyboard engagement features, housing engagement features, magnetic alignment systems, etc. described above. A user may align keyboard 802 with housing 803 such that a plurality of keyboard engagement features and plurality of housing engagement features align in a first position. The user may then slide keyboard 802 toward a “front” side of housing 803 (e.g., a side furthest from the side where housing 803 is hingedly coupled to a display housing) such that combined edge connector 801 mechanically and electrically couples to a corresponding connector of the information handling system and such that the plurality of keyboard engagement features mechanically engage with the plurality of housing engagement features, securing keyboard 802 to housing 803.

While the terms “top,” “bottom,” “front,” and “back” are used for purposes of exposition and clarity, such terms are not intended to limit any of the components disclosed herein to a particular orientation or configuration.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a keyboard comprising a plurality of chassis engagement features; and
a chassis comprising a plurality of keyboard engagement features, wherein:
the keyboard is configured to slide relative to the chassis in a first direction such that the plurality of chassis engagement features mechanically couple to the plurality of keyboard engagement features; and
the keyboard is configured to slide relative to the chassis in a second direction such that the plurality of chassis engagement features mechanically uncouple from the plurality of keyboard engagement features.

2. The information handling system of claim 1, wherein:
the plurality of chassis engagement features comprise a plurality of standoffs coupled to the keyboard; and
the plurality of keyboard engagement features comprise a plurality of openings formed in the chassis.

3. The information handling system of claim 1, wherein:
the plurality of chassis engagement features comprise a plurality of latch structures coupled to the keyboard; and
the plurality of keyboard engagement features comprise:
a plurality of openings configured to receive the plurality of latch structures; and
a plurality of hook structures configured to mechanically couple to the plurality of latch structures.

4. The information handling system of claim 1, wherein:
the plurality of chassis engagement features comprise a plurality of recesses formed in the keyboard; and
the plurality of keyboard engagement features comprise a plurality of standoffs coupled to the chassis.

5. The information handling system of claim 1, wherein the keyboard further comprises a plurality of alignment structures and the chassis comprises a plurality of alignment holes, wherein the plurality of alignment structures are configured to align with the plurality of alignment holes when the plurality of keyboard engagement features are mechanically coupled to the plurality of chassis engagement features.

6. The information handling system of claim 1, wherein the chassis further comprises a first plurality of magnets configured to magnetically couple to the keyboard.

7. The information handling system of claim 6, wherein the keyboard further comprises a second plurality of magnets configured to magnetically couple to the first plurality of magnets, wherein the first plurality of magnets are further configured to facilitate alignment of the keyboard relative to the chassis.

8. The information handling system of claim 1, wherein the keyboard further comprises a combined card edge connector, wherein the combined card edge connector comprises a plurality of edge connectors and is configured to electrically couple to a connector of the information handling system.

9. A method for making an information handling system comprising:
forming a keyboard comprising a plurality of chassis engagement features; and
forming a chassis comprising a plurality of keyboard engagement features, wherein:
the keyboard is configured to slide relative to the chassis in a first direction such that the plurality of chassis engagement features mechanically couple to the plurality of keyboard engagement features; and
the keyboard is configured to slide relative to the chassis in a second direction such that the plurality of chassis engagement features mechanically uncouple from the plurality of keyboard engagement features.

10. The method of claim 9, wherein:
forming the keyboard comprises coupling a plurality of standoffs to the keyboard; and
forming the chassis comprises forming a plurality of openings in the chassis.

11. The method of claim 9, wherein:
forming the keyboard comprises coupling a plurality of latch structures to the keyboard; and
forming the chassis comprises:
forming a plurality of openings configured to receive the plurality of latch structures; and
forming a plurality of hook structures configured to mechanically couple to the plurality of latch structures.

12. The method of claim 9, wherein:
forming the keyboard comprises forming a plurality of recesses in the keyboard; and
forming the chassis comprises coupling a plurality of standoffs to the chassis.

13. The method of claim 9, wherein:
forming the keyboard further comprises coupling a plurality of alignment structures to the keyboard; and
forming the chassis further comprises forming a plurality of alignment holes in the chassis, wherein the plurality of alignment structures are configured to align with the plurality of alignment holes when the plurality of keyboard engagement features are mechanically coupled to the plurality of chassis engagement features.

14. The method of claim 9, wherein forming the chassis further comprises coupling a first plurality of magnets to the chassis, wherein the first plurality of magnets is configured to magnetically couple to the keyboard.

15. The method of claim 14, wherein forming the keyboard further comprises coupling a second plurality of magnets to the keyboard, wherein the second plurality of magnets is configured to magnetically couple to the first plurality of magnets, and wherein the first plurality of magnets is further configured to facilitate alignment of the keyboard relative to the chassis.

16. The method of claim 9, wherein forming the keyboard further comprises coupling a combined card edge connector to the keyboard, wherein the combined card edge connector comprises a plurality of edge connectors and is configured to electrically couple to a connector of the information handling system.

17. A method of assembling a keyboard to a chassis of an information handling system comprising sliding the keyboard relative to the chassis in a first direction such that a plurality of chassis engagement features of the keyboard mechanically couple to a plurality of keyboard engagement features of the chassis.

18. The method of claim 17, further comprising aligning a plurality of alignment structures of the keyboard with a plurality of alignment holes of the chassis, wherein the plurality of alignment structures align with the plurality of alignment holes when the plurality of keyboard engagement features are mechanically coupled to the plurality of chassis engagement features.

19. The method of claim 17, wherein mechanically coupling the plurality of chassis engagement features to the plurality of keyboard engagement features comprises mechanically coupling a plurality of standoffs of the keyboard to a plurality of openings formed in the chassis such that movement of the keyboard is constrained relative to the chassis.

20. The method of claim 17, further comprising sliding the keyboard relative to the chassis in a second direction such that the plurality of chassis engagement features decouples from the plurality of keyboard engagement features.
